(19) United States
(12) Patent Application Publication
(10) Pub. No.: US 2012/0188747 A1
(43) Pub. Date: Jul. 26, 2012

(54) LIGHTING DEVICE AND DISPLAY DEVICE

(75) Inventor: Takashi Mine, Osaka-shi (JP)

(73) Assignee: SHARP KABUSHIKI KAISHA, Osaka-shi, Osaka (JP)

(21) Appl. No.: 13/499,036

(22) PCT Filed: Jun. 4, 2010
(86) PCT No.: PCT/JP2010/059544

§ 371 Date: Mar. 29, 2012

(30) Foreign Application Priority Data
Oct. 30, 2009 (JP) 2009-250954

(51) Int. Cl. G09F 13/04; F21V 29/00

(52) U.S. Cl. 362/97.1

(57) ABSTRACT

Disclosed is a lighting device (3) including light-emitting diodes (light source) (23) and an LED substrate (circuit substrate) (22) provided with the light-emitting diodes (23). The lighting device (3) includes a heat-dissipation plate (heat-dissipation member) (25) that dissipates heat from the light-emitting diodes (23). The LED substrate (circuit substrate) (22) includes a mount portion (22a) on which the light-emitting diodes (23) are mounted, and first and second heat-transfer portions (22b1, 22b2) that are provided continuously to the mount portion (22a) and that transfer heat from the light-emitting diodes (23). In the LED substrate (22), the first and second heat-transfer portions (22b1, 22b2) are attached to be in close contact with the heat-dissipation plate (25).

### TECHNICAL FIELD

The present invention relates to a lighting device provided with a light source, and a display device using the same.

### BACKGROUND ART

Recently, for example, a liquid crystal display device has been used widely in a liquid crystal television, a monitor, a mobile phone, etc., as a flat panel display that has features such as a smaller thickness and a lighter weight as compared with a conventional Braun tube. Such a liquid crystal display device includes a lighting device (backlight device) that emits light, and a liquid crystal panel that displays a desired image by serving as a shutter with respect to light from a light source provided in the lighting device.

The above-described lighting device is classified roughly into a direct type and an edge-light type depending on the arrangement of the light source with respect to the liquid crystal panel. For example, a liquid crystal display device for use in mobile equipment such as a mobile phone, a notebook PC, and a PDA generally adopts the edge-light type, which achieves a smaller thickness more easily than the direct type. More specifically, the edge-light type lighting device includes the light source on a side of the liquid crystal panel for achieving a smaller thickness, and uses a light-guiding plate that has a light-emitting surface opposed to a non-display surface of the liquid crystal panel so as to irradiate the liquid crystal panel with light from the light source.

Further, as described in the following Patent Document 1 for example, a light-emitting diode (LED) has been proposed as the light source of a conventional lighting device. Further, the conventional lighting device has adopted a LED substrate on which a plurality of aligned light-emitting diodes are mounted. Further, in the conventional lighting device, for dissipating heat generated at the light-emitting diodes, a heat-dissipation material made of a sheet metal material such as aluminum is in close contact with the LED substrate.

### PRIOR ART DOCUMENT

### Patent Document

Patent Document ii JP 2007-26916 A

### DISCLOSURE OF INVENTION

### Problem to be Solved by the Invention

In the lighting device as described above, a smaller thickness is demanded, and a width dimension of the LED substrate (circuit substrate) is required to be reduced accordingly.

However, in the conventional lighting device as described above, when the thickness is reduced, there is a possibility that heat generated at light-emitting diodes (light source) cannot be dissipated properly.

Specifically, in the conventional lighting device, heat generated at the light-emitting diodes is dissipated using the heat-dissipation material with its end portion being in close contact with the surface of the LED substrate on which the light-emitting diodes are mounted. Because of this, in the conventional lighting device, when the width dimension of the LED substrate is reduced, it becomes difficult to secure a space for attaching the end portion of the heat-dissipation material to the LED substrate, which prevents a proper dissipation of heat generated at the light-emitting diodes.

In view of the above-described problem, it is an object of the present invention to provide a lighting device capable of dissipating heat generated at light sources properly even when a smaller thickness is achieved, and a display device using the same.

### Means for Solving Problem

To achieve the above object, a lighting device according to the present invention includes a light source and a circuit substrate provided with the light source, and further includes a heat-dissipation member that dissipate heat from the light source. The circuit substrate is provided with a mount portion on which the light source is mounted and a heat-transfer portion that is provided continuously to the mount portion and that transfers heat from the light source. In the circuit substrate, the heat-transfer portion is attached so as to be in close contact with the heat-dissipation member.

In the lighting device configured as above, the circuit substrate includes the mount portion on which the light source is mounted and the heat-transfer portion that is provided continuously to the mount portion and that transfers heat from the light source. Further, in the circuit substrate, the heat-transfer portion is attached to be in close contact with the heat-dissipation member. Thereby, even when a width dimension of the circuit substrate is reduced by downsizing a width dimension of the mount portion, heat generated at the light source can be transferred via the heat-transfer portion to the heat-dissipation member efficiently. Consequently, unlike the conventional example described above, even when a smaller thickness is achieved, it is possible to configure a lighting device capable of dissipating heat generated at the light source properly.

Further, in the above lighting device, it is preferable that the heat-transfer portion is formed orthogonally to the mount portion.

In this case, the width dimension of the circuit substrate can be prevented reliably from being increased, whereby the thickness of the lighting device can be reduced easily.

Further, in the above lighting device, in the circuit substrate, first and second heat-transfer portions respectively may be provided continuously to one end side and the other end side of the mount portion so that the first and second heat-transfer portions are parallel to each other. Further, the first and second heat-transfer portions may be attached to the heat-dissipation member, with the heat-dissipation member being interposed therebetween.

In this case, even when the width dimension of the circuit substrate is reduced, heat generated at the light source can be transferred via the first and second heat-transfer portions to the heat-dissipation member more efficiently.

Further, in the above lighting device, in the circuit substrate, the mount portion and the heat-transfer portion may be provided continuously so as to have an L-shape in cross section.

In this case, not only a cost of the circuit substrate but also a cost of the lighting device can be reduced easily by downsizing the circuit substrate.

Further, it is preferable that the above lighting device further includes a housing that houses the circuit substrate, wherein the circuit substrate and the heat-dissipation member are installed on the housing by an installation member that has a thermal conductivity and that is attached to the heat-transfer portion.

In this case, since the circuit substrate and the heat-dissipation member can be installed on the housing by the installation member, heat generated at the light source can be dissipated also from the housing, whereby the heat can be dissipated more properly. Further, since the installation member having a thermal conductivity is used, heat generated at the light source can be transferred to the housing more efficiently. Moreover, since the installation member is attached to the heat-transfer portion, the light source can be mounted on the mount portion properly unlike the case of attaching the installation member to the mount portion, whereby the occurrence of brightness unevenness can be prevented easily.

Further, in the above lighting device, a size of the heat-transfer portion is determined based on a size of the installation member.

In this case, when the circuit substrate and the heat-dissipation member are installed on the housing by the installation member, not only the cost of the circuit substrate but also the cost of the lighting device can be reduced by downsizing the circuit substrate.

Further, it is preferable that the above lighting device further includes a light-guiding plate that has a light-incident surface for receiving light of the light source and a light-emitting surface for emitting light incident from the light-incident surface and that emits light from the light-emitting surface while guiding light incident from the light-incident surface to a predetermined propagation direction, wherein the light-guiding plate is installed in the housing, with the light-incident surface being opposed to the light source of the circuit substrate.

In this case, light of the light source can be emitted easily from the light-emitting surface, as illumination light without brightness unevenness.

Further, in the above lighting device, it is preferable that the circuit substrate includes a fixing portion for fixing the light-guiding plate, and is installed movably with respect to the housing while fixing the light-guiding plate.

In this case, even when the light-guiding plate contracts or expands due to an ambient temperature, a predetermined distance between the light source and the light-incident surface of the light-guiding plate can be kept constant. Thereby, the decrease in light use efficiency and the occurrence of brightness unevenness of the light source can be prevented.

Further, in the above lighting device, it is preferable that a reflecting sheet for reflecting light of the light source is provided on a surface of the fixing portion on the light-guiding plate side.

In this case, since the reflecting sheet allows light of the light source to enter the light-incident surface of the light-guiding plate, the decrease in light use efficiency of the light source can be prevented reliably.

Further, in the above lighting device, it is preferable that the circuit substrate is provided with an opposed portion that is opposed to the fixing portion so that an end portion of the light-guiding plate is interposed between the opposed portion and the fixing portion.

In this case, since light of the light source is allowed to enter the light-incident surface of the light-guiding plate reliably, the decrease in light use efficiency of the light source can be prevented more reliably.

Further, in the above lighting device, it is preferable that a reflecting sheet for reflecting light of the light source is provided on a surface of the opposed portion on the light-guiding plate side.

In this case, since the reflecting sheet allows light of the light source to enter the light-incident surface of the light-guiding plate, the decrease in light use efficiency of the light source can be prevented reliably.

Further, in the above lighting device, in the circuit substrate, a heat-dissipation sheet may be provided so as to be in close contact with a rear surface of the mount portion, and may be in close contact with the heat-dissipation member.

In this case, since the heat-dissipation sheet can transfer heat generated at the light source to the heat-dissipation member more efficiently, heat generated at the light source can be dissipated more properly even when a smaller thickness is achieved.

Further, in the above lighting device, it is preferable that a light-emitting diode is used as the light source.

In this case, an environmentally-friendly lighting device having excellent light emission quality can be configured easily.

Further, a display device of the present invention includes any one of the above lighting devices.

In the display device configured as above, since the lighting device is used that can dissipate heat generated at the light source properly even when a smaller thickness is achieved, it is possible to configure a compact, high-performance display device easily.

### Effect of the Invention

According to the present invention, it is possible to provide a lighting device capable of dissipating heat generated at light sources properly even when a smaller thickness is achieved, and a display device using the same.

### BRIEF DESCRIPTION OF DRAWINGS

FIG. 1 is a view illustrating a lighting device and a liquid crystal display device according to Embodiment 1 of the present invention.

FIG. 2 is a diagram illustrating a configuration of a liquid crystal panel shown in FIG. 1.

FIG. 3 is a plan view illustrating a configuration of main portions of the lighting device shown in FIG. 1.

FIG. 4A is a plan view showing an LED unit shown in FIG. 3, and

FIG. 4B is a cross-sectional view taken along a line IVb-IVb in FIG. 4A.

FIG. 5 is a plan view illustrating a configuration of main portions of a lighting device according to Embodiment 2 of the present invention.

FIG. 6A is a plan view showing an LED unit shown in FIG. 5, and

FIG. 6B is a cross-sectional view taken along a line VIb-VIb in FIG. 6A.

FIG. 7 is a plan view illustrating a configuration of main portions of a lighting device according to Embodiment 3 of the present invention.

FIG. 8A is a plan view showing an LED unit shown in FIG. 7, and

FIG. 8B is a cross-sectional view taken along a line VIIIb-VIIIb in FIG. 8A.

FIG. 9 is a plan view illustrating a configuration of main portions of a lighting device according to Embodiment 4 of the present invention.

FIG. 10A is a plan view showing an LED unit shown in FIG. 9, and

FIG. 10B is a cross-sectional view taken along a line Xb-Xb in FIG. 10A.

FIG. 11A is a view illustrating a screw and a screw hole shown in FIG. 10B, and FIGS. 11B and 11C are views respectively illustrating the behavior of a light-guiding plate in the case where the light-guiding plate contracts and expands.

FIG. 12 is a plan view illustrating a configuration of main portions of a lighting device according to Embodiment 5 of the present invention.

FIG. 13A is a plan view showing an LED unit shown in FIG. 12, and

FIG. 13B is a cross-sectional view taken along a line XIIIb-XIIIb in FIG. 13A.

FIG. 14 is a view illustrating effects of reflecting sheets shown in FIG. 13B.

### DESCRIPTION OF THE INVENTION

Hereinafter, preferred embodiments of a lighting device and a display device of the present invention will be described with reference to the drawings. In the following description, the present invention is applied to a transmission-type liquid crystal display device. Further, the dimensions of constituent members in the drawings do not faithfully reflect the actual dimensions of constituent members, dimension ratio of the respective constituent members, etc.

### Embodiment 1

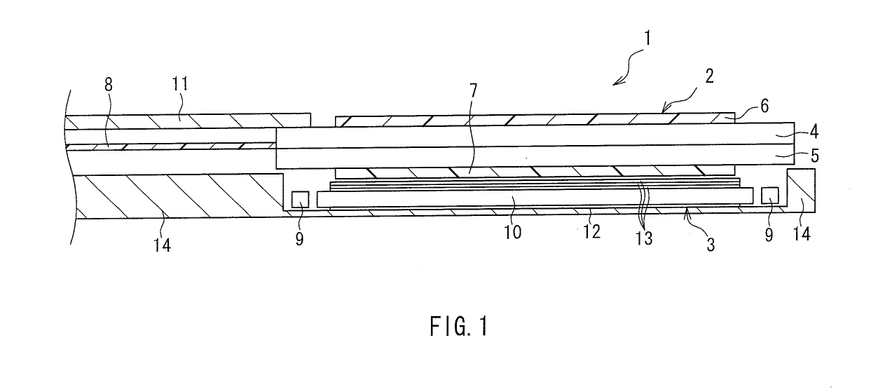

FIG. 1 is a view illustrating a lighting device and a liquid crystal display device according to Embodiment 1 of the present invention. In FIG. 1, a liquid crystal display device 1 of the present embodiment is provided with a liquid crystal panel 2 and a lighting device 3. An upper side of the liquid crystal panel 2 in FIG. 1 is defined as a viewing side (display surface side). The lighting device 3 is arranged on a non-display surface side (lower side in FIG. 1) of the liquid crystal panel 2 and generates illumination light for illuminating the liquid crystal panel 2.

The liquid crystal panel 2 includes a color filter substrate 4 and an active matrix substrate 5 that constitute a pair of substrates, and polarizing plates 6, 7 that are provided on outer surfaces of the color filter substrate 4 and the active matrix substrate 5, respectively. A liquid crystal layer (not shown) is sandwiched between the color filter substrate 4 and the active matrix substrate 5. The color filter substrate 4 and the active matrix substrate 5 are made of a flat plate-shaped transparent glass material or a transparent synthetic resin such as an acrylic resin. The polarizing plates 6, 7 are made of a resin film such as TAC (triacetyl cellulose) or PVA (polyvinyl alcohol). The polarizing plates 6, 7 are bonded to the corresponding color filter substrate 4 or active matrix substrate 5 so as to cover at least an effective display region of a display surface of the liquid crystal panel 2.

Further, the active matrix substrate 5 constitutes one of the pair of substrates and includes pixel electrodes, TFTs (Thin Film Transistor), etc., that are formed between the active matrix substrate 5 and the liquid crystal layer in accordance with a plurality of pixels included in the display surface of the liquid crystal panel 2 (detailed later). Meanwhile, the color filter substrate 4 constitutes the other of the pair of substrates and includes color filters, counter electrodes, etc., that are formed between the color filter substrate 4 and the liquid crystal layer (not shown).

Further, the liquid crystal panel 2 is provided with a FPC (Flexible Printed Circuit) 8 that is connected to a control device (not shown) that performs drive control of the liquid crystal panel 2. The display surface is driven on a pixel basis by operating the liquid crystal layer on a pixel basis, whereby a desired image can be displayed on the display surface.

Note here that the liquid crystal panel 2 can have any liquid crystal mode and any pixel structure. The liquid crystal panel 2 also can have any drive mode. In other words, any liquid crystal panel capable of displaying information can be used as the liquid crystal panel 2. Therefore, a detailed structure of the liquid crystal panel 2 is not illustrated in FIG. 1, and a description thereof is omitted.

The lighting device 3 includes an LED unit portion 9 that includes light-emitting diodes (LED) as light sources, and a light-guiding plate 10 that is arranged to be opposed to the LED unit portion 9. In the lighting device 3 of the present embodiment, the LED unit portion 9 is placed so as to be opposed to four respective side surfaces of the light-guiding plate 10 (detailed later). Further, in the lighting device 3, the LED unit portion 9 and the light-guiding plate 10 are sandwiched by a bezel 14 having an L-shape in cross section, with the liquid crystal panel 2 being located on the upper side of the light-guiding plate 10. The bezel 14 constitutes an external case of the lighting device 3 and constitutes a housing that houses an LED substrate (described later). A case 11 is mounted on the color filter substrate 4. Thereby, the lighting device 3 is attached to the liquid crystal panel 2, and they are integrated as the transmission-type liquid crystal display device 1 in which illumination light from the lighting device 3 enters the liquid crystal panel 2.

The light-guiding plate 10 is made of a synthetic resin such as a transparent acrylic resin and receives light from the light-emitting diodes contained in the LED unit portion 9, as detailed later. A reflecting sheet 12 is placed on a surface of the light-guiding plate 10 on a side opposite to the liquid crystal panel 2 side (opposed surface side). Further, optical sheets 13 such as a lens sheet and a diffusion sheet are provided on a surface of the light-guiding plate 10 on the liquid crystal panel 2 side (light-emitting surface side). Light from the light-emitting diodes that is guided inside the light-guiding plate 10 in a predetermined propagation direction is transformed into planar illumination light having a uniform brightness, and given to the liquid crystal panel 2.

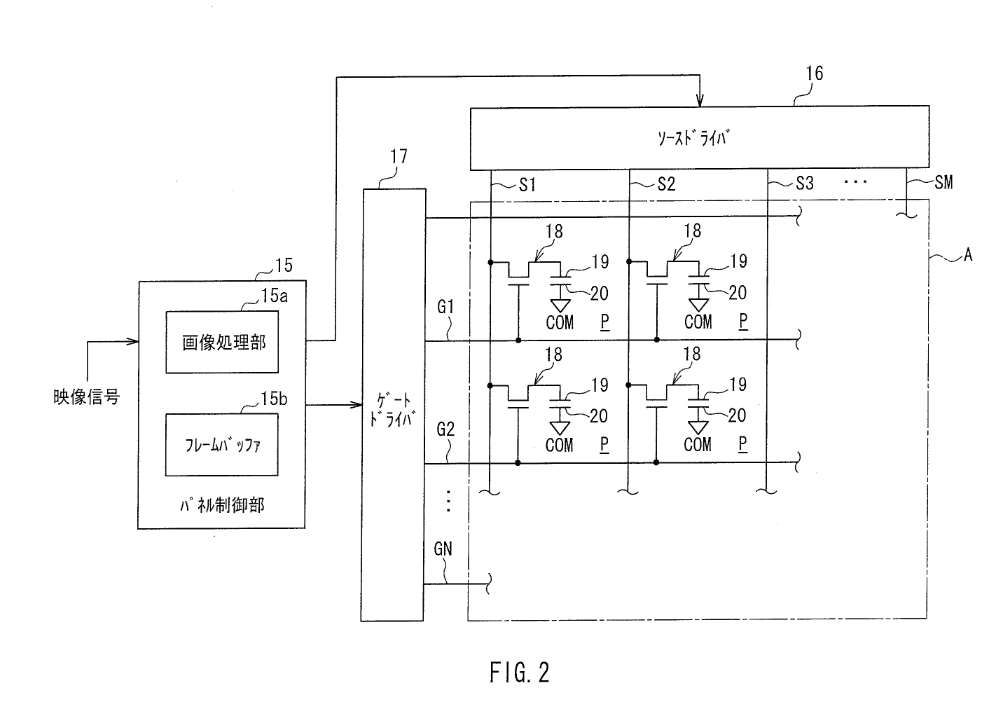

Next, the liquid crystal panel 2 of the present embodiment will be described specifically also with reference to FIG. 2.

FIG. 2 is a diagram illustrating a configuration of the liquid crystal panel shown in FIG. 1.

In FIG. 2, the liquid crystal display device 1 (FIG. 1) is provided with a panel control portion 15 that performs drive control of the liquid crystal panel 2 (FIG. 1) as the display portion that displays information such as characters and images, and a source driver 16 and a gate driver 17 that are operated based on instruction signals from the panel control portion 15.

The panel control portion 15 is provided in the control device and receives a video signal from outside of the liquid crystal display device 1. Further, the panel control portion 15 includes an image processing portion 15a that performs predetermined image processing on input video signals so as to generate respective instruction signals to the source driver 16 and the gate driver 17, and a frame buffer 15b that can store one frame of display data contained in the input video signals. The panel control portion 15 performs drive control of the source driver 16 and the gate driver 17 in accordance with input video signals, whereby information in accordance with the video signals is displayed on the liquid crystal panel 2.

The source driver 16 and the gate driver 17 are disposed on the active matrix substrate 5. Specifically, on a surface of the active matrix substrate 5, the source driver 16 is disposed along the horizontal direction of the liquid crystal panel 2 in an outside region of an effective display area A of the liquid crystal panel 2 as a display panel. Further, the gate driver 17 is disposed along the vertical direction of the liquid crystal panel 2 in the outside region of the effective display area A on the surface of the active matrix substrate 5.

Further, the source driver 16 and the gate driver 17 are drive circuits that drive, on a pixel basis, a plurality of pixels P provided on the liquid crystal panel 2 side.

The source driver 16 and the gate driver 17 are connected respectively to a plurality of source lines S1-SM (M is an integer of 2 or more; hereinafter, referred to as “S” collectively) and a plurality of gate lines G1-GN (N is an integer of 2 or more; hereinafter, referred to as “G” collectively). The source lines S and the gate lines G constitute data lines and scanning lines, respectively, which are arranged in a matrix so as to cross each other on a base material (not shown) made of a transparent glass material or a transparent synthetic resin contained in the active matrix substrate 5. In other words, the source lines S are formed on the base material so as to be parallel to a column direction in the matrix (the vertical direction of the liquid crystal panel 2) and the gate lines G are formed on the base material so as to be parallel to a row direction in the matrix (the horizontal direction of the liquid crystal panel 2).

Further, in the vicinity of each intersection between the source lines S and the gate lines G, the thin film transistor 18 as a switching element and the pixel P that has a pixel electrode 19 connected to the thin film transistor 18 are provided. Further, in each of the pixels P, a common electrode 20 is opposed to the pixel electrode 19, with the liquid crystal layer of the liquid crystal panel 2 being interposed therebetween. In other words, in the active matrix substrate 5, the thin film transistor 18, the pixel electrode 19 and the common electrode 20 are provided per pixel.

Further, in the active matrix substrate 5, in the respective regions partitioned in a matrix by the source lines S and the gate lines G, a plurality of regions of the pixels P are formed. The plurality of pixels P include red (R), green (G) and blue (B) pixels. The RGB pixels are arranged sequentially in parallel to the gate lines G1-GN in this order, for example. Further, the RGB pixels can display corresponding color by color filter layers (not shown) provided on the color filter substrate 4 side.

Further, in the active matrix substrate 5, the gate driver 17 sequentially outputs scanning signals (gate signal) to the gate lines G1-GN so as to bring gate electrodes of the corresponding thin film transistors 18 to an ON state, based on instruction signals from the image processing portion 15a. Further, the source driver 16 outputs data signals (voltage signal (gradation voltage)) in accordance with brightness (gradation) of the display image to the corresponding source lines S1-SM, based on instruction signals from the image processing portion 15a.

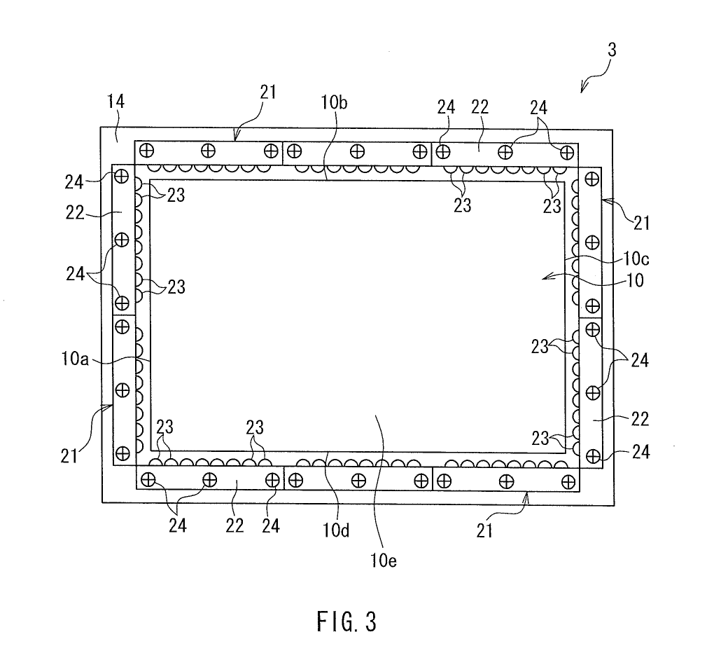

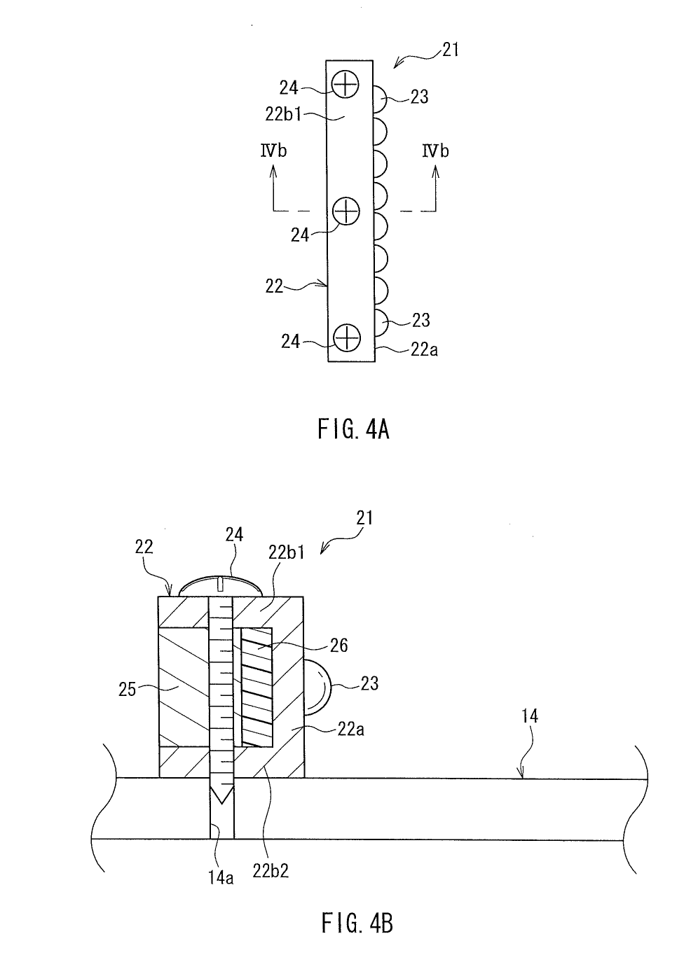

Next, the lighting device 3 of the present embodiment will be described specifically also with reference to FIGS. 3, 4A and 4B.

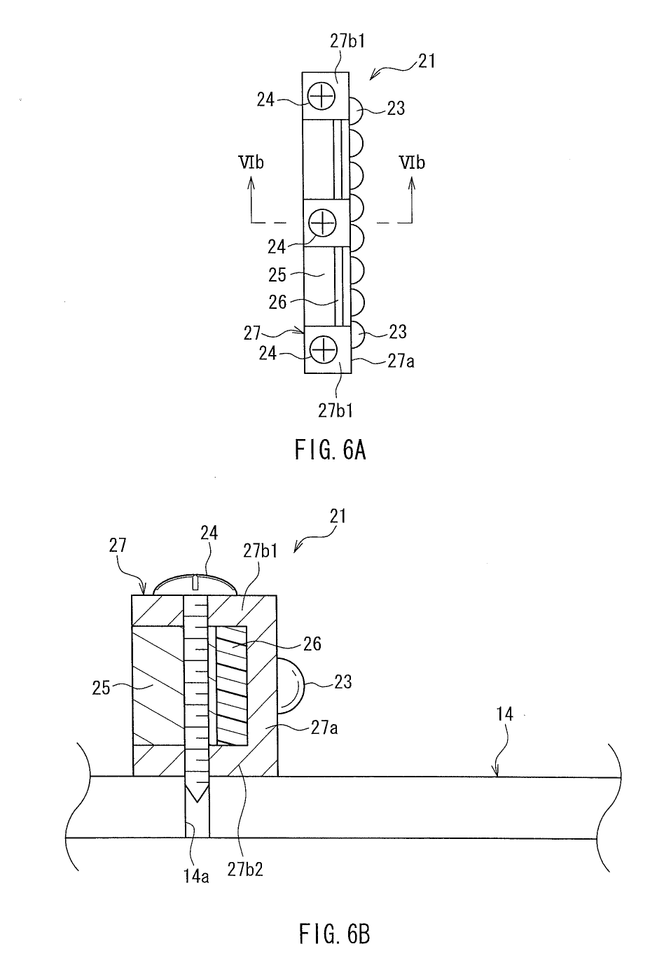

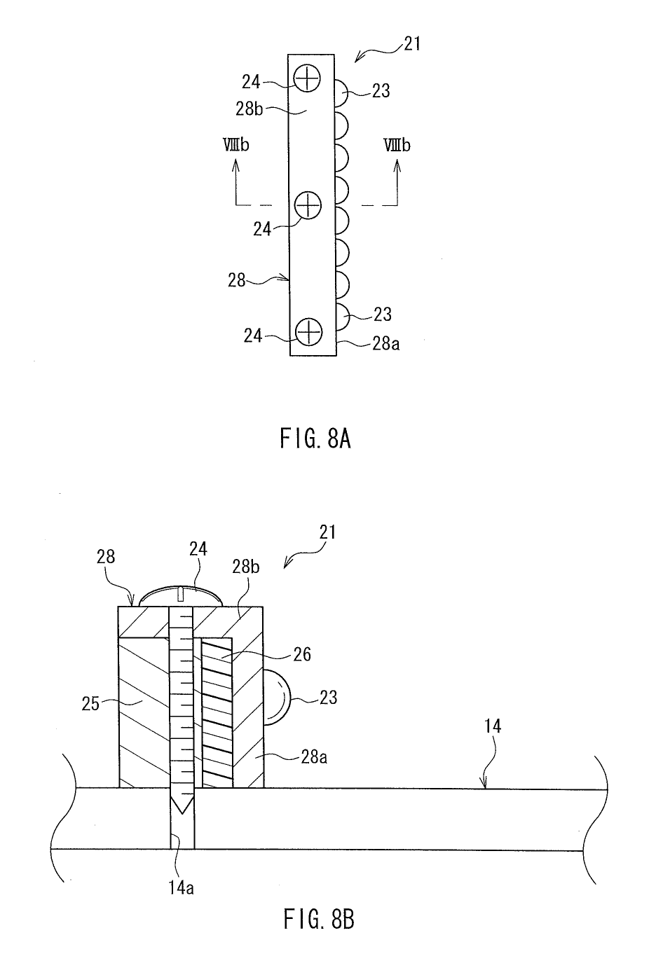

FIG. 3 is a plan view illustrating a configuration of main portions of the lighting device shown in FIG. 1. FIG. 4A is a plan view showing the LED unit shown in FIG. 3, and FIG. 4B is a cross-sectional view taken along a line IVb-IVb in FIG. 4A. In FIG. 4A, the illustration of the bezel and the light-guiding plate is omitted (the same applies to FIGS. 6A, 8A, 10A and 13A in the following). Further, in FIG. 4B, the illustration of the light-guiding plate is omitted (the same applies to FIGS. 6B and 8B in the following).

As exemplified in FIG. 3, in the lighting device 3 of the present embodiment, the bezel (housing) 14 includes the light-guiding plate 10 and the LED unit portion 9 (FIG. 1) that is provided so as to surround four side surfaces 10a, 10b, 10c and 10d of the light-guiding plate 10. Specifically, in the light-guiding plate 10, two each of LED units 21 contained in the LED unit portion 9 are arranged to be opposed to the side surfaces 10a and 10c, which are on the left and right sides of FIG. 3, respectively. Further, three each of LED units 21 contained in the LED unit portion 9 are arranged to be opposed to the side surfaces 10b and 10d, which are on the upper and lower sides of FIG. 3, respectively.

The LED unit 21 includes an LED substrate 22 as a circuit substrate and a plurality of (e.g., eight) light-emitting diodes (light source) 23 provided in the LED substrate 22. Further, in the LED unit 21, the light-emitting diodes 23 are attached to the bezel 14 by a plurality of (e.g., three) screws 24 in such a manner as to be opposed to any one of the side surfaces 10a-10d. Thereby, in the light-guiding plate 10, each of the side surfaces 10a-10d can function as a light-incident surface that receives light from the light-emitting diodes 23. Further, in the light-guiding plate 10, light incident from one of the light-incident surfaces is guided to a predetermined propagation direction toward another light-incident surface that is opposed to the light-incident surface, and output from a light-emitting surface 10e to the liquid crystal panel 2 side as the illumination light.

Further, as shown in FIG. 4A, in the LED unit 21, eight light-emitting diodes 23 are aligned at a predetermined interval and mounted on a mount portion 22a of the LED substrate 22. The LED substrate 22 is made of, for example, an aluminum substrate or a flexible substrate having a thickness of about 1-2 mm.

Further, as shown in FIG. 4B, the LED substrate 22 includes the mount portion 22a, and first and second heat-transfer portions 22b1, 22b2 that respectively are provided continuously to one end side and the other end side of the mount portion 22a. Thus, heat generated at the light-emitting diodes 23 can be transferred from the mount portion 22a to the first and second heat-transfer portions 22b1, 22b2. Further, in the LED substrate 22, the first and second heat-transfer portions 22b1, 22b2 are formed orthogonally to the mount portion 22a so that the first and second heat-transfer portions 22b1, 22b2 are parallel to each other. In other words, in the LED substrate 22, as shown in FIG. 4B, the mount portion 22a and the first and second heat-transfer portions 22b1, 22b2 have a U-shape in cross section. Further, a width dimension of the mount portion 22a (i.e., a dimension of the LED substrate 22 in a vertical direction in FIG. 4B) is, for example, about 2-4 mm, which contributes to a smaller thickness of the lighting device 3.

Further, in the LED substrate 22, the heat-dissipation plate 25 as a heat-dissipation member is attached so as to be interposed between the first and second heat-transfer portions 22b1, 22b2. The heat-dissipation plate 25 is made of a metallic block material having an excellent thermal conductivity such as aluminum. In other words, the heat-dissipation plate 25 has a rectangular shape in cross section and has the same dimension as a length dimension of the LED substrate 22 (a dimension in the vertical direction in FIG. 4A), and further is attached integrally to the LED substrate 22 by the screws 24 while being in close contact with inner surfaces of the first and second heat-transfer portions 22b1, 22b2. Thus, the heat-dissipation plate 25 dissipates heat that is generated at the light-emitting diodes 23 and transferred sequentially from the mount portion 22a and the first and second heat-transfer portions 22b1, 22b2.

Further, in the LED substrate 22, as shown in FIG. 4B, a heat-dissipation sheet 26 is attached to be in close contact with a rear surface of the mount portion 22a and the heat-dissipation plate 25. Similarly to the heat-dissipation plate 25, the heat-dissipation sheet 26 has a rectangular shape in cross section and has the same dimension as the length dimension of the LED substrate 22 (a dimension in the vertical direction in FIG. 4A). Further, a filler of the heat-dissipation sheet 26 is silicon base, acrylic base, or a graphite sheet. The heat-dissipation sheet 26 transfers heat generated at the light-emitting diodes 23 from the mount portion 22a toward the heat-dissipation plate 25.

Further, by using the screws 24 as installation members, the LED substrate 22 is attached not only to the heat-dissipation plate 25 and the heat-dissipation sheet 26 but also to the bezel (housing) 14. In other words, when the screw 24 is screwed into a screw hole 14a formed in the bezel 14, the LED unit 21 that includes the LED substrate 22, the heat-dissipation plate 25 and the heat-dissipation sheet 26 is attached to the bezel 14. Further, the screw 24 is made of, for example, a metal having a thermal conductivity, whereby heat of the light-emitting diodes 23 transferred to the first and second heat-transfer portions 22b1, 22b2 and the heat-dissipation plate 25 can be transferred to the bezel 14. In the lighting device 3 of the present embodiment, heat of the light-emitting diodes 23 can be dissipated also in the bezel 14. Moreover, in the lighting device 3 of the present embodiment, as shown in FIG. 4B, since the second heat-transfer portion 22b2 is attached to be in direct contact with the bezel 14, heat of the light-emitting diodes 23 is transferred from the second heat-transfer portion 22b2 to the bezel 14 directly, and dissipated at the bezel 14.

In the lighting device 3 of the present embodiment configured as above, the LED substrate (circuit substrate) 22 includes the mount portion 22a on which the light-emitting diodes (light source) 23 are mounted, and the first and second heat-transfer portions 22b1, 22b2 that are provided continuously to the mount portion 22a and that transfer heat from the light-emitting diodes 23. Further, in the LED substrate 22, the first and second heat-transfer portions 22b1, 22b2 are attached so as to be in close contact with the heat-dissipation plate (heat-dissipation member) 25. Thereby, in the lighting device 3 of the present embodiment, even when the width dimension of the LED substrate 22 is reduced by downsizing the width dimension of the mount portion 22a, heat generated at the light-emitting diodes 23 can be transferred efficiently to the heat-dissipation plate 25 via the first and second heat-transfer portions 22b1, 22b2. Consequently, in the present embodiment, unlike the conventional example described above, even when a smaller thickness is achieved, the lighting device 3 can dissipate heat generated at the light-emitting diodes 23 properly.

Further, in the LED substrate 22 of the present embodiment, the first and second heat-transfer portions 22b1, 22b2 respectively are provided continuously to one end side and the other end side of the mount portion 22a so that the first and second heat-transfer portions 22b1, 22b2 are parallel to each other. Further, the first and second heat-transfer portions 22b1, 22b2 are attached to the heat-dissipation plate 25, with the heat-dissipation plate 25 interposed therebetween. Thereby, in the present embodiment, even when the width dimension of the LED substrate 22 is reduced, the heat generated at the light-emitting diodes 23 can be transferred more efficiently to the heat-dissipation plate 25 via the first and second heat-transfer portions 22b1, 22b2.

Further, in the present invention, the light-guiding plate 10 is used that includes the side surfaces 10a-10d as the light-incident surfaces, and the light-emitting surface 10e that emits light of the light-emitting diodes 23 incident from the side surfaces 10a-10d to the liquid crystal panel 2 side. Thereby, light of the light-emitting diodes 23 can be emitted easily from the light-emitting surface 10e to the liquid crystal panel 2 side, as the illumination light without brightness unevenness.

Further, in the present invention, the lighting device 3 is used that can dissipate heat generated at the light-emitting diodes 23 properly even when a smaller thickness is achieved. Thereby, a compact, high-performance liquid crystal display device 1 can be configured easily.

In the above description, a block material having a rectangular shape in cross section is used as the heat-dissipation plate (heat-dissipation member) 25. However, the heat-dissipation plate 25 of the present embodiment is not limited to this. For example, it is possible to use a heat-dissipation plate having a plurality of heat-dissipation fins on a surface thereof on a side opposite to the heat-dissipation sheet 26 (the same applies to each of the following embodiments).

### Embodiment 2

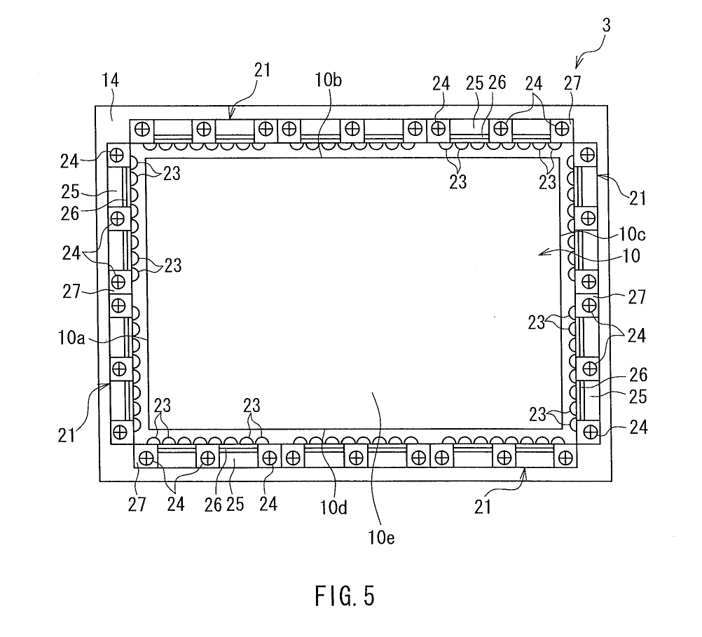

FIG. 5 is a plan view illustrating a configuration of main portions of a lighting device according to Embodiment 2 of the present invention. FIG. 6A is a plan view showing an LED unit shown in FIG. 5, and FIG. 6B is a cross-sectional view taken along a line VIb-VIb in FIG. 6A. In FIGS. 5 and 6, the present embodiment mainly differs from above-described Embodiment 1 in that a size of the first heat-transfer portion is determined based on a size of the screw. The same components as those in the above-described Embodiment 1 are denoted with the same reference numerals, and the explanation will not repeated.

As shown in FIGS. 5, 6A and 6B, the LED unit 21 of the present embodiment is provided with an LED substrate 27 as a circuit substrate and a plurality of (e.g., eight) light-emitting diodes (light source) 23 that are attached to the LED substrate 27.

Similarly to the LED substrate of Embodiment 1, the LED substrate 27 includes a mount portion 27a on which eight light-emitting diodes 23 aligned at a predetermined interval are mounted, and first and second heat-transfer portions 27b1, 27b2 that respectively are provided continuously to one end side and the other end side of the mount portion 27a.

Further, in the LED substrate 27, similarly to the LED substrate of Embodiment 1, the first and second heat-transfer portions 27b1, 27b2 are formed orthogonally to the mount portion 27a so that the first and second heat-transfer portions 27b1, 27b2 are parallel to each other. In other words, in the LED substrate 27, as shown in FIG. 6B, the mount portion 27a and the first and second heat-transfer portions 27b1, 27b2 have a U-shape in cross section.

However, in the LED substrate 27 of the present embodiment, as exemplified in FIG. 6A, the size of the first heat-transfer portion 27b1 is determined based on the size of the screw 24, which is different from Embodiment 1. In other words, the LED substrate 27 of the present embodiment is divided into three first heat-transfer portions 27b1 depending on the installation location of the screws 24, and the size of each of the three first heat-transfer portions 27b1 (surface area on the liquid crystal panel 2 side) is determined depending on the size of the screw 24.

With the above configuration, the present embodiment can provide the same function and effect as those of the above-described Embodiment 1. Further, in the lighting device 3 of the present embodiment, in the LED substrate (circuit substrate) 27, the size of the first heat-transfer portion 27b1 is determined based on the size of the screw (installation member) 24. Thereby, even when the LED substrate 27 and the heat-dissipation plate (heat-dissipation member) 25 are installed on the bezel (housing) 14 by the screws 24, not only a cost of the LED substrate 27 but also a cost of the lighting device 3 can be reduced by downsizing the LED substrate 27.

### Embodiment 3

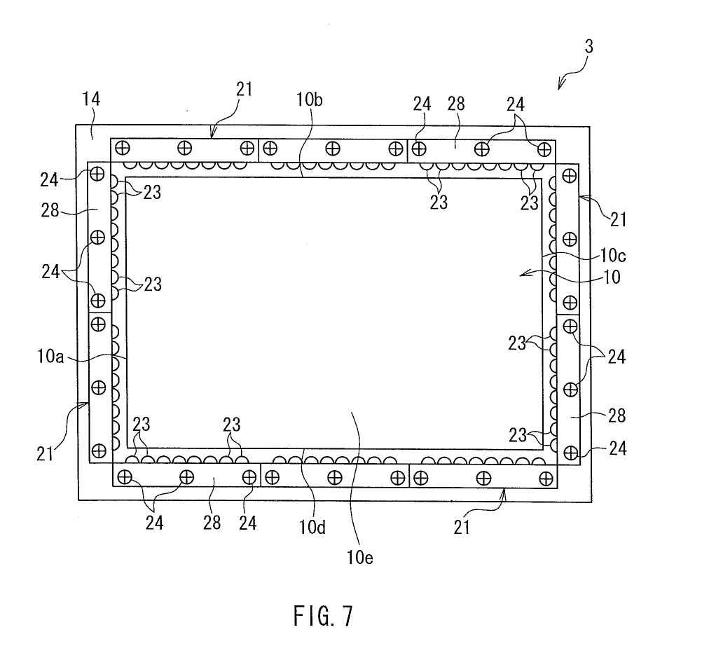

FIG. 7 is a plan view illustrating a configuration of main portions of a lighting device according to Embodiment 3 of the present invention. FIG. 8A is a plan view showing an LED unit shown in FIG. 7, and FIG. 8B is a cross-sectional view taken along a line VIIIb-VIIIb in FIG. 8A. In FIGS. 7 and 8, the present embodiment mainly differs from above-described Embodiment 1 in that, in the LED substrate, the mount portion and the heat-transfer portion are provided continuously so as to have an L-shape in cross section. The same components as those in the above-described Embodiment 1 are denoted with the same reference numerals, and the explanation will not repeated.

As shown in FIGS. 7, 8A and 8B, the LED unit 21 of the present embodiment is provided with an LED substrate 28 as a circuit substrate and a plurality of (e.g., eight) light-emitting diodes (light source) 23 that are attached to the LED substrate 28.

The LED substrate 28 includes a mount portion 28a on which eight light-emitting diodes 23 aligned at a predetermined interval are mounted, and a heat-transfer portion 28b that is provided continuously to one end side of the mount portion 28a. Further, in the LED substrate 28, as shown in FIG. 8B, the heat-transfer portion 28b is formed orthogonally to the mount portion 28a. The mount portion 28a and the heat-transfer portion 28b are provided continuously so as to have an L-shape in cross section.

Further, in the LED unit 21 of the present embodiment, as shown in FIG. 8B, the LED substrate 28, the heat-dissipation plate 25 and the heat-dissipation sheet 26 are attached to the bezel 14 by the screws 24, with the other end of the mount portion 28a, an end surface of the heat-dissipation plate 25 and an end surface of the heat-dissipation sheet 26 being in close contact with a surface of the bezel 14. Thereby, heat of the light-emitting diodes 23 is transferred directly from the other end of the mount portion 28a, the end surface of the heat-dissipation plate 25 and the end surface of the heat-dissipation sheet 26 to the bezel 14, whereby the heat can be dissipated at the bezel 14.

With the above configuration, the present embodiment can provide the same function and effect as those of the above-described Embodiment 1. Further, in the lighting device 3 of the present embodiment, in the LED substrate (circuit substrate) 28, the mount portion 28a and the heat-transfer portion 28b are provided continuously so as to have an L-shape in cross section. Thereby, not only a cost of the LED substrate 28 but also a cost of the lighting device 3 can be reduced easily by downsizing the LED substrate 28.

### Embodiment 4

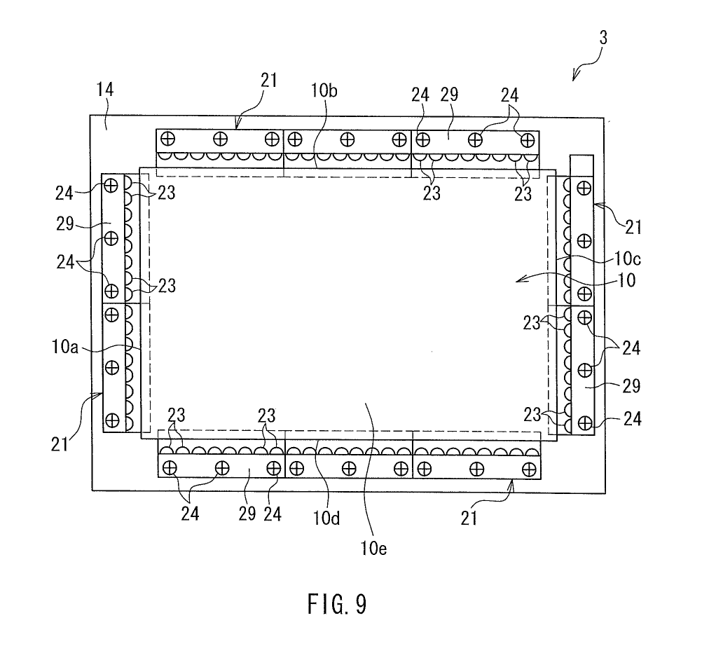

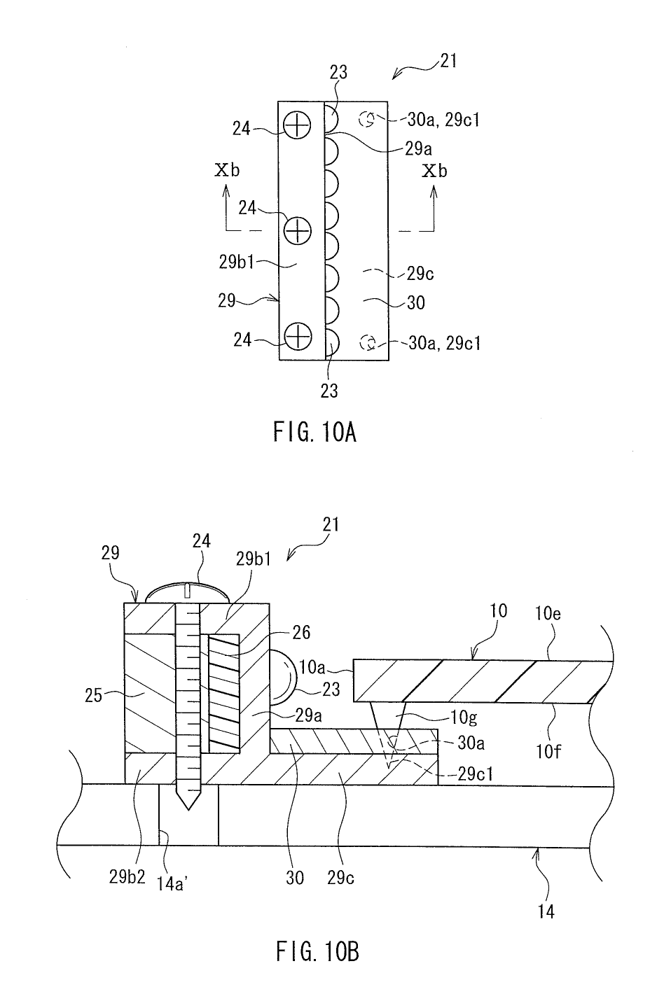

FIG. 9 is a plan view illustrating a configuration of main portions of a lighting device according to Embodiment 4 of the present invention. FIG. 10A is a plan view showing an LED unit shown in FIG. 9, and FIG. 10B is a cross-sectional view taken along a line Xb-Xb in FIG. 10A. In FIGS. 9 and 10, the present embodiment mainly differs from above-described Embodiment 1 in that the LED substrate includes a fixing portion for fixing the light-guiding plate, and is installed movably with respect to the bezel while fixing the light-guiding plate. The same components as those in the above-described Embodiment 1 are denoted with the same reference numerals, and the explanation will not repeated.

As shown in FIGS. 9, 10A and 10B, the LED unit 21 of the present embodiment is provided with an LED substrate 29 as a circuit substrate and a plurality of (e.g., eight) light-emitting diodes (light source) 23 that are attached to the LED substrate 29.

The LED substrate 29 includes a mount portion 29a on which eight light-emitting diodes 23 aligned at a predetermined interval are mounted, first and second heat-transfer portions 29b1, 29b2 that respectively are provided continuously to one end side and the other end side of the mount portion 29a, and a fixing portion 29c, for fixing the light-guiding plate 10, that is provided continuously to the other end side of the mount portion 29a and the second heat-transfer portion 29b2.

Further, in the LED substrate 29, similarly to the LED substrate of Embodiment 1, the first and second heat-transfer portions 29b1, 29b2 are formed orthogonally to the mount portion 29a so that the first and second heat-transfer portions 29b1, 29b2 are parallel to each other. In other words, in the LED substrate 29, as shown in FIG. 10B, the mount portion 29a and the first and second heat-transfer portions 29b1, 29b2 have a U-shape in cross section.

Further, in the LED substrate 29, the fixing portion 29c is provided orthogonally to the mount portion 29a on the other end side of the mount portion 29a and extends on a side opposite to the second heat-transfer portion 29b2. On a surface of the fixing portion 29c on the light-guiding plate 10 side, a reflecting sheet 30 is provided, thereby allowing light of the light-emitting diodes 23 to enter the inside of the light-guiding plate 10 by reflection. Further, for example, a polyethylene-based or a polyester-based reflecting sheet 30 is used.

Further, as exemplified in FIG. 10A, in the fixing portion 29c and the reflecting sheet 30, two fixing holes 29c1, 30a, which are to be engaged with a rib (protrusion) 10g provided on the light-guiding plate 10, are formed, respectively. In other words, in an end portion of the light-guiding plate 10 of the present embodiment, the rib 10g is formed on an opposed surface 10f that is opposite to the light-emitting surface 10e of the light-guiding plate 10. By inserting the rib 10g into the fixing holes 29c1, 30a, the light-guiding plate 10 is fixed to the fixing portion 29c (i.e., the LED substrate 29).

Further, the LED substrate 29 is installed movably with respect to the bezel 14 while fixing the light-guiding plate 10. Specifically, in the present embodiment, a screw hole 14a′ formed in the bezel 14 has an elliptical shape (slot shape). By fastening the screws 24 loosely to some extent, the LED substrate 29 is attached to the bezel 14 in a state of being movable in right and left directions in FIG. 10B with respect to the bezel 14. Thus, in the present embodiment, even in the case where the light-guiding plate 10 contracts or expands due to an influence such as an ambient temperature, a predetermined distance between the light-emitting diodes 23 and the light-incident surfaces of the light-guiding plate 10 (e.g., side surface 10a) can be kept constant. In addition to this description, the LED substrate 29 can be configured to be movable with respect to the bezel 14 by applying a lubricant such as grease between the bezel 14 and the LED substrate 29.

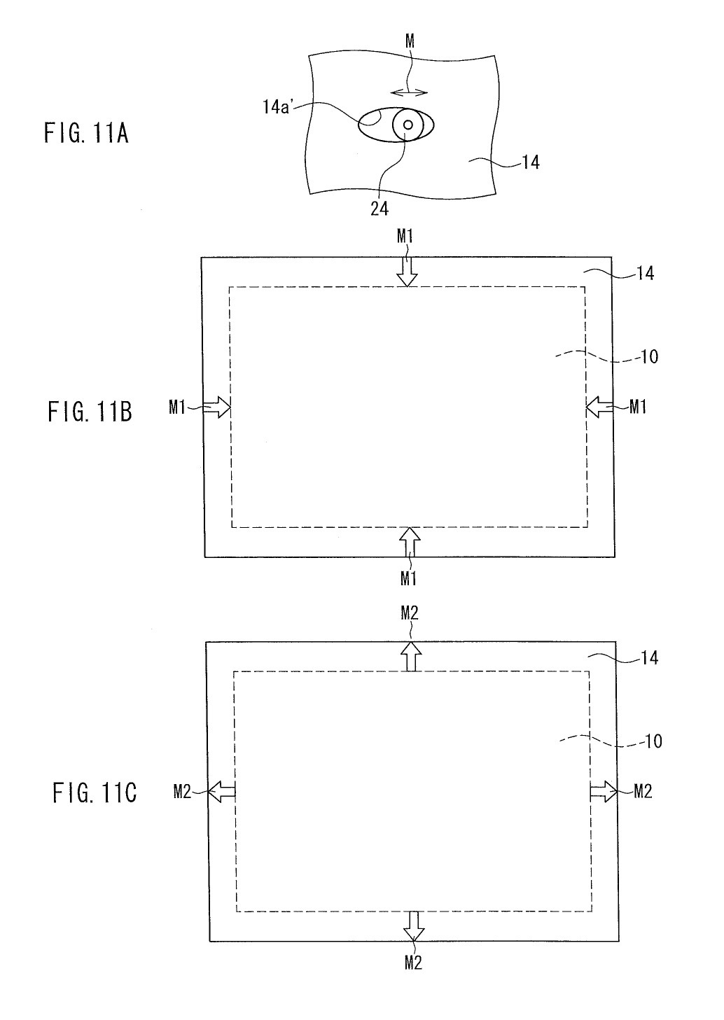

Here, a configuration in the lighting device 3 of the present embodiment that makes it possible to keep a predetermined distance between the light-emitting diodes 23 and the light-incident surfaces of the light-guiding plate 10 constant will be described specifically with reference to FIGS. 11A, 11B and 11C.

FIG. 11A is a view illustrating the screw and the screw hole shown in FIG. 10B, and FIGS. 11B and 11C are views respectively illustrating the behavior of the light-guiding plate in the case where the light-guiding plate contracts and expands.

As shown in FIG. 11A, the screw hole 14a′ is formed larger than a tip of the screw 24 and has an elliptical shape. Thus, in the present embodiment, the screw 24 is movable in directions indicated by a double-sided arrow M in FIG. 11A. Consequently, when the light-guiding plate 10 contracts in accordance with the decrease of an ambient temperature as indicated by arrows M1 in FIG. 11B or when the light-guiding plate 10 expands in accordance with the increase of an ambient temperature as indicated by arrows M2 in FIG. 11C, the LED substrate 29 is allowed to move in the directions indicated by the arrows M1 or M2 while fixing the light-guiding plate 10. Therefore, in the present embodiment, even when the light-guiding plate 10 contracts or expands, a predetermined distance between the light-emitting diodes 23 and the light-incident surfaces of the light-guiding plate 10 can be kept constant.

With the above configuration, the present embodiment can provide the same function and effect as those of the above-described Embodiment 1. Further, in the lighting device 3 of the present embodiment, the LED substrate (circuit substrate) 29 is provided with the fixing portion 29c for fixing the light-guiding plate 10, and installed movably with respect to the bezel (housing) 14 while fixing the light-guiding plate 10. Thus, in the lighting device 3 of the present embodiment, even when the light-guiding plate 10 contracts or expands due to an ambient temperature, a predetermined distance between the light-emitting diodes (light source) 23 and the light-incident surfaces of the light-guiding plate 10 can be kept constant. Thereby, the decrease in light use efficiency and the occurrence of brightness unevenness of the light-emitting diodes 23 can be prevented.

Further, since the fixing portion 29c is provided continuously to the mount portion 29a and is in close contact with the bezel 14, heat generated at the light-emitting diodes 23 can be transferred from the fixing portion 29c to the bezel 14 for being dissipated. Thus, a heat-dissipation effect of the LED substrate 29 can be improved.

Further, since the reflecting sheet 30 for reflecting light of the light-emitting diodes 23 is provided on the surface of the fixing portion 29c on the light-guiding plate 10 side, the light of the light-emitting diodes 23 is allowed to enter the light-incident surfaces of the light-guiding plate 10 by the reflecting sheet 30. Thus, the decrease in light use efficiency of the light-emitting diodes 23 can be prevented reliably.

In the above description, although the light-guiding plate 10 and the LED substrate 29 are fixed using the rib 10g and the fixing holes 29c1, 30a, the present embodiment is not limited to this. For example, the light-guiding plate 10 and the LED substrate 29 may be fixed using a transparent adhesive sheet (the same applies to Embodiment 5 in the following).

Further, in addition to the above description, in place of the reflecting sheet 30, a white paint, a silver paint or the like having a high light reflectance may be applied to the surface of the fixing portion 29c on the light-guiding plate 10 side, in order to allow light of the light-emitting diodes 23 to enter the inside of the light-guiding plate 10.

### Embodiment 5

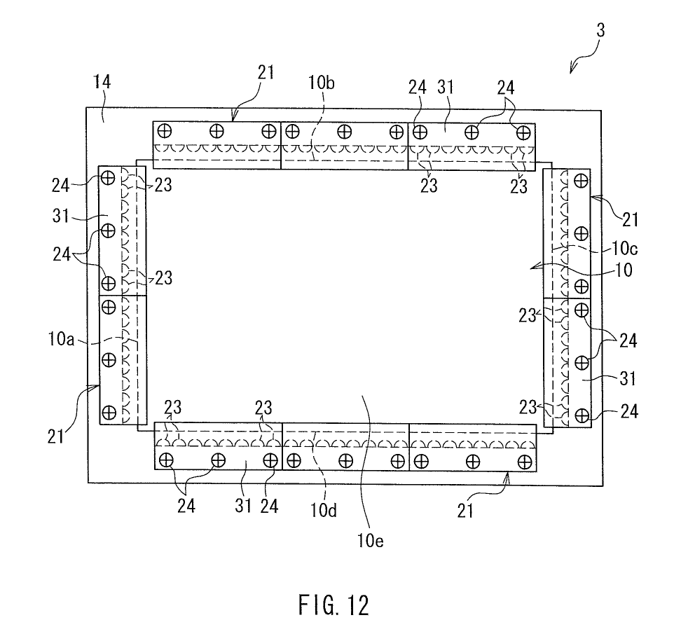

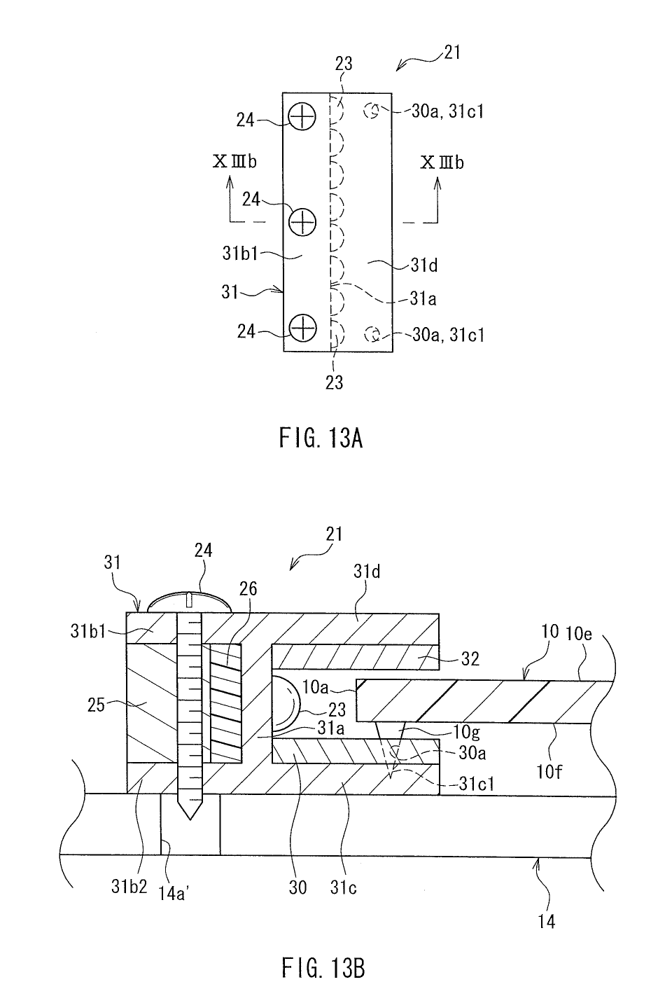

FIG. 12 is a plan view illustrating a configuration of main portions of a lighting device according to Embodiment 5 of the present invention. FIG. 13A is a plan view showing an LED unit shown in FIG. 12, and FIG. 13B is a cross-sectional view taken along a line XIIIb-XIIIb in FIG. 13A. In FIGS. 12 and 13, the present embodiment mainly differs from above-described Embodiment 4 in that the LED substrate is provided with an opposed portion that is opposed to the fixing portion so that an end portion of the light-guiding plate is interposed between the opposed portion and the fixing portion. The same components as those in the above-described Embodiment 4 are denoted with the same reference numerals, and the explanation will not repeated.

As shown in FIGS. 12, 13A and 13B, the LED unit 21 of the present embodiment is provided with an LED substrate 31 as a circuit substrate and a plurality of (e.g., eight) light-emitting diodes (light source) 23 that are attached to the LED substrate 31.

Similarly to the LED substrate of Embodiment 4, the LED substrate 31 includes a mount portion 31a on which eight light-emitting diodes 23 aligned at a predetermined interval are mounted, first and second heat-transfer portions 31b1, 31b2 that respectively are provided continuously to one end side and the other end side of the mount portion 31a, and a fixing portion 31c, for fixing the light-guiding plate 10, that is provided continuously to the other end side of the mount portion 31a and the second heat-transfer portion 31b2. Further, the LED substrate 31 includes an opposed portion 31d that is provided continuously to one end side of the mount portion 31a and the first heat-transfer portion 31b1 and that is opposed to the fixing portion 31c with the end portion of the light-guiding plate 10 being interposed between the opposed portion 31d and the fixing portion 31c.

Further, in the LED substrate 31, the fixing portion 31c is provided orthogonally to the mount portion 31a on the other end side of the mount portion 31a and extends on a side opposite to the second heat-transfer portion 31b2. On a surface of the fixing portion 31c on the light-guiding plate 10 side, similarly to the fixing portion of Embodiment 4, a reflecting sheet 30 is provided, thereby allowing light of the light-emitting diodes 23 to enter the inside of the light-guiding plate 10 by reflection.

Further, as exemplified in FIG. 13A, in the fixing portion 31c and the reflecting sheet 30, two fixing holes 31c1, 30a, which are to be engaged with a rib (protrusion) 10g provided on the light-guiding plate 10, are formed, respectively. In other words, in the end portion of the light-guiding plate 10 of the present embodiment, similarly to the light-guiding plate of Embodiment 4, the rib 10g is formed on an opposed surface 10f that is opposite to the light-emitting surface 10e of the light-guiding plate 10. By inserting the rib 10g into the fixing holes 31c1, 30a, the light-guiding plate 10 is fixed to the fixing portion 31c (i.e., the LED substrate 31).

Further, in the LED substrate 31, the opposed portion 31d is provided orthogonally to the mount portion 31a on one end side of the mount portion 31a and extends on a side opposite to the first heat-transfer portion 31b1. On a surface of the opposed portion 31d on the light-guiding plate 10 side, similarly to the LED substrate of Embodiment 4, a reflecting sheet 32 is provided, thereby allowing light of the light-emitting diodes 23 to enter the inside of the light-guiding plate 10 by reflection.

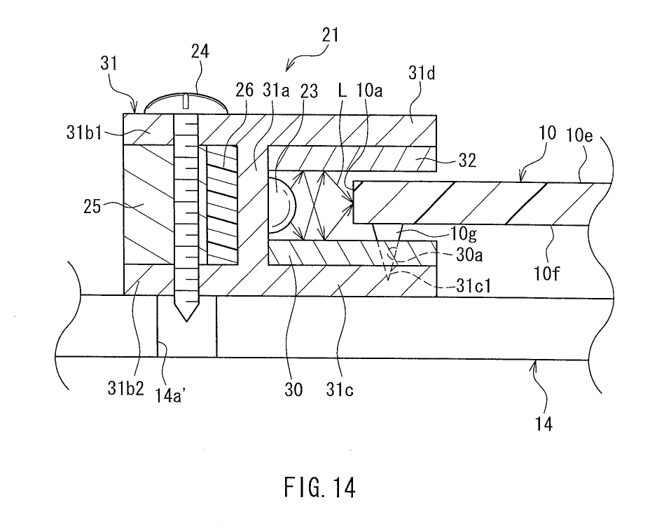

Here, effects of the reflecting sheets 30, 32 in the present embodiment will be described specifically with reference to FIG. 14.

FIG. 14 is a view illustrating effects of the reflecting sheets shown in FIG. 13B.

As shown in FIG. 14, in the present embodiment, the light-emitting diode 23 is arranged to be opposed to the side surface (light-incident surface) 10a, with the end portion of the light-guiding plate 10 being interposed between the reflecting sheets 30, 32. Because of this, as indicated by an arrow L in FIG. 14, light from the light-emitting diode 23 is reflected alternately by the reflecting sheets 30, 32, thereby entering the side surface 10a.

With the above configuration, the present embodiment can provide the same function and effect as those of the above-described Embodiment 4. Further, in the lighting device 3 of the present embodiment, in the LED substrate (circuit substrate) 31, the opposed portion 31d that is opposed to the fixing portion 31c is provided so that the end portion of the light-guiding plate 10 is interposed between the fixing portion 31c and the opposed portion 31d. Thus, light of the light-emitting diodes (light source) 23 is allowed to enter the light-incident surfaces of the light-guiding plate 10 reliably, and hence the decrease in light use efficiency of the light sources can be prevented more reliably.

Further, since the opposed portion 31d is provided continuously to the mount portion 31a, it also is possible to dissipate heat generated at the light-emitting diodes 23 by the opposed portion 31d, whereby the heat-dissipation effect of the LED substrate 31 can be improved.

Further, since the reflecting sheet 32 for reflecting light of the light-emitting diodes 23 is provided on the surface of the opposed portion 31d on the light-guiding plate 10 side, the light of the light-emitting diodes 23 is allowed to enter the light-incident surfaces of the light-guiding plate 10 by the reflecting sheet 32. Thus, the decrease in light use efficiency of the light-emitting diodes 23 can be prevented reliably.

Further, in addition to the above description, in place of the reflecting sheet 32, a white paint, a silver paint or the like having a high light reflectance may be applied to the surface of the opposed portion 31d on the light-guiding plate 10 side, in order to allow light of the light-emitting diodes 23 to enter the inside of the light-guiding plate 10.

Note here that the above embodiments are all illustrative and not restrictive. The technological scope of the present invention is defined by the appended claims, and all changes that come within the range of equivalency of the claims are intended to be embraced therein.

For example, in the above description, the present invention is applied to the transmission type liquid crystal display device. However, the lighting device of the present invention is not limited thereto, and may be applied to various display devices having a non-luminous display portion that displays information such as images and characters by utilizing light of light sources. Specifically, the lighting device of the present invention can be used suitably in a semi-transmission type liquid crystal display device or a projection type display device using a liquid crystal panel as a light valve.

Further, in the above description, the LED substrate (circuit substrate) and the heat-dissipation plate (heat-dissipation member) are installed on the bezel (housing) using screws (installation member). However, the lighting device of the present invention is not particularly limited thereto, as long it has the following configuration: the lighting device includes a light source and a circuit substrate provided with the light source, and further includes a heat-dissipation member that dissipate heat from the light source, wherein the circuit substrate is provided with a mount portion on which the light source is mounted and a heat-transfer portion that is provided continuously to the mount portion and that transfers heat from the light source, and in the circuit substrate, the heat-transfer portion is attached so as to be in close contact with the heat-dissipation member.

Note here that, as described in each of the above embodiments, the following case is preferred: the circuit substrate and the heat-dissipation member are installed with respect to the housing that houses the circuit substrate, by the installation member that has a thermal conductivity and that is attached to the heat-transfer portion. This is because heat generated at the light source can be dissipated also from the housing, which permits more proper dissipation of the heat. Further, the use of the installation member having a thermal conductivity is preferred because the heat generated at the light source can be transferred to the housing more efficiently. Moreover, the attachment of the installation member to the heat-transfer portion is preferred because, unlike the case where the installation member is attached to the mount portion, the light source can be mounted on the mount portion properly, which can prevent the occurrence of brightness unevenness easily.

Further, in the above description, the LED substrate (circuit substrate) having a U-shape or L-shape in cross section is used. However, the circuit substrate of the present invention is not limited thereto, as long as the mount portion and the heat-transfer portion are provided continuously.

Note here that, as described in each of the above embodiments, the case where the heat-transfer portion is formed orthogonally to the mount portion is preferred because the width dimension of the circuit substrate can be prevented reliably from being increased, whereby the thickness of the lighting device can be reduced easily.

Further, in the above description, four side surfaces of the light-guiding plate are caused to function as light-incident surfaces by arranging the light-emitting diodes (light source) to be opposed to the four side surfaces. However, the lighting device of the present invention is not limited thereto, as long as at least one of the side surfaces is opposed to the light sources so as to function as a light-incident surface.

Further, in the above description, the heat-dissipation sheet is attached to the LED substrate (circuit substrate). However, the lighting device of the present invention is not limited thereto, and the placement of the heat-dissipation sheet may be omitted.

Note here that, as described in each of the above embodiments, the use of the heat-dissipation sheet that is in close contact with the rear surface of the mount surface of the LED substrate (circuit substrate) and the heat-dissipation member is preferred because the heat-dissipation sheet can transfer heat generated at the light sources to the heat-dissipation member more efficiently; besides, even when a smaller thickness is achieved, the heat generated at the light sources can be dissipated more properly.

Further, in the above description, light-emitting diodes are used as light sources. However, the light source of the present invention is not limited thereto, and for example, point light sources such as lamps and linear light sources such as cold cathode fluorescent tubes also can be used.

Note here that, as described in each of the above embodiments, the use of the light-emitting diodes as light sources is preferred because an environmentally-friendly lighting device having excellent light emission quality can be configured easily.

### INDUSTRIAL APPLICABILITY

The present invention is useful with respect to a lighting device capable of dissipating heat generated at light sources properly even when a smaller thickness is achieved, and a display device using the same.

### DESCRIPTION OF REFERENCE NUMERALS

1 liquid crystal display device (display device)
3 lighting device
10 light-guiding plate
10a, 10b, 10c, 10d side surface (light-incident surface)
10e light-emitting surface
14 bezel (housing)
22, 27, 28, 29, 31 LED substrate (circuit substrate)
22a, 27a, 28a, 29a, 31a mount portion
22b1, 22b2, 27b1, 27b2, 28b, 29b1, 29b2, 31b1, 31b2 heat-transfer portion
29c, 31c fixing portion
31d opposed portion
23 light-emitting diode (light source)
24 screw (installation member)
25 heat-dissipation plate (heat-dissipation member)
26 heat-dissipation sheet
30, 32 reflecting sheet

1: A lighting device comprising a light source and a circuit substrate provided with the light source,
the lighting device comprising a heat-dissipation member that dissipate heat from the light source,
wherein the circuit substrate is provided with a mount portion on which the light source is mounted and a heat-transfer portion that is provided continuously to the mount portion and that transfers heat from the light source, and
in the circuit substrate, the heat-transfer portion is attached so as to be in close contact with the heat-dissipation member.

2: The lighting device according to claim 1, wherein the heat-transfer portion is formed orthogonally to the mount portion.

3: The lighting device according to claim 1,
wherein, in the circuit substrate, first and second heat-transfer portions respectively are provided continuously to one end side and the other end side of the mount portion so that the first and second heat-transfer portions are parallel to each other, and
the first and second heat-transfer portions are attached to the heat-dissipation member, with the heat-dissipation member being interposed therebetween.

4: The lighting device according to claim 1, wherein, in the circuit substrate, the mount portion and the heat-transfer portion are provided continuously so as to have an L-shape in cross section.

5: The lighting device according to claim 1, further comprising a housing that houses the circuit substrate, wherein the circuit substrate and the heat-dissipation member are installed on the housing by an installation member that has a thermal conductivity and that is attached to the heat-transfer portion.

6: The lighting device according to claim 5, wherein a size of the heat-transfer portion is determined based on a size of the installation member.

7: The lighting device according to claim 1, further comprising a light-guiding plate that has a light-incident surface for receiving light of the light source and a light-emitting surface for emitting light incident from the light-incident surface and that emits light from the light-emitting surface while guiding light incident from the light-incident surface to a predetermined propagation direction,
wherein the light-guiding plate is installed in the housing, with the light-incident surface being opposed to the light source of the circuit substrate.

8: The lighting device according to claim 7, wherein the circuit substrate includes a fixing portion for fixing the light-guiding plate, and is installed movably with respect to the housing while fixing the light-guiding plate.

9: The lighting device according to claim 8, wherein a reflecting sheet for reflecting light of the light source is provided on a surface of the fixing portion on the light-guiding plate side.

10: The lighting device according to claim 8, wherein the circuit substrate is provided with an opposed portion that is opposed to the fixing portion so that an end portion of the light-guiding plate is interposed between the opposed portion and the fixing portion.

11: The lighting device according to claim 10, wherein a reflecting sheet for reflecting light of the light source is provided on a surface of the opposed portion on the light-guiding plate side.

12: The lighting device according to claim 1, wherein in the circuit substrate, a heat-dissipation sheet is provided so as to be in close contact with a rear surface of the mount portion, and is in close contact with the heat-dissipation member.

13: The lighting device according to claim 1, wherein a light-emitting diode is used as the light source.

14: A display device comprising the lighting device according to claim 1.
